(19) United States
(12) Patent Application Publication
(10) Pub. No.: US 2006/0293877 A1
(43) Pub. Date: Dec. 28, 2006

(54) Method and apparatus for uni-lingual workflow usage in multi-lingual data center environments

(76) Inventor: Baldev Singh Soor, Markham (CA)

Correspondence Address: IBM CORP (YA);C/O YEE & ASSOCIATES PC, P.O. BOX 802333, DALLAS, TX, 75380, US

(21) Appl. No.: 11/167,244

(22) Filed: Jun. 27, 2005

(51) Int. Cl. G06F 17/20

(52) U.S. Cl. 704/8

(57) ABSTRACT

A method and apparatus for allowing uni-lingual workflows to manage devices in multi-lingual data center environments. When a managed device in the multi-lingual data center environment is obtained, the mechanism of the present invention identifies the language and locale environment settings of the managed device. A pre-execution process is performed on the device, wherein the pre-execution operation saves the language and locale environment settings of the managed device, and then changes the language and locale environment settings to those expected by the uni-lingual workflow. The workflow is then executed on the device. The mechanism of the present invention performs a post-execution operation on the device, wherein the post-execution operation restores the language and locale environment settings of the managed device from the settings expected by the uni-lingual workflow to the saved language and locale environment settings. The managed device is then released.

### BACKGROUND OF THE INVENTION

1. Field of the Invention

The present invention relates generally to an improved data processing system, and in particular, to a method and system for uni-lingual workflows usage in multi-lingual data center environments.

2. Description of the Related Art

A workflow may be created to manage devices in a data center environment. FIG. 1 illustrates a known general process for executing a workflow on a managed device. In this process, a workflow may generally be targeted to work on a device in three stages. In the first stage, the workflow process first obtains the device (step 102). The process then executes the workflow on the device (step 104). Once the workflow has run, the process releases the device (step 106).

Traditionally, workflows, created to manage devices in a data center, tacitly make two assumptions. First, the workflows assume that when a query is sent to a device being managed, the device will always respond to the query in English. Second, the workflows assume that the data center is language-homogeneous or uni-lingual, wherein all of the devices only respond in a single natural language, such as English. A uni-lingual environment, such as uni-lingual environment 200 in FIG. 2, is an environment in which the same workflow may be used to manage any of the devices 202-210. The same workflow may be expected to work properly in the uni-lingual environment because the language setting 212 and locale setting 214 of all of the devices are the same.

However, these assumptions may create problems for global data centers, which have devices that run software products set to respond to queries in languages other than English. A global data center may comprise a multi-lingual environment, such as multi-lingual environment 300 in FIG. 3. A multi-lingual environment poses problems for workflows, as devices 302-310 in the environment may contain different language 312 and locale environment settings 314. For example, the global data center may have devices located in different geographies and set to respond to queries in other languages, such as Japanese, German, and Arabic. In a multi-lingual environment, the result of a workflow executed on a device that does not respond in the expected language may be undefined. For instance, the result of executing the workflow may be undefined when a condition to perform a particular task has to be satisfied in the workflow, but due to the natural language difference between the workflow and the device, the task is never performed because the workflow never registers that the condition has been satisfied.

One method in the current art that allows for executing workflows in a multi-lingual environment creates a workflow for each natural language. For example, in FIG. 4, when the device is obtained (step 402), the language on the device is identified (step 404). Based on the language identified, logic is used to select and load the appropriate natural language workflow for the device (step 406). Once the appropriate language workflow has run (step 408), the device is released (step 410). However, this conventional method is problematic since a workflow must be created for each natural language. Thus, if workflows have only been created in English, German, and French, a device that responds in Arabic will not be able to be managed by the workflow, since an Arabic workflow has not been created. In addition, maintenance of these workflows may be a problem as well, since updates made to one workflow need to be made to the corresponding workflows in the other languages.

### SUMMARY OF THE INVENTION

Embodiments of the present invention provide an improved mechanism for allowing uni-lingual workflows to manage devices in multi-lingual data center environments. When a managed device in the multi-lingual data center environment is obtained, the mechanism of the present invention identifies the language and locale environment settings of the managed device. A pre-execution process is performed on the device, wherein the pre-execution operation saves the language and locale environment settings of the managed device, and then changes the settings to the language and locale environment settings expected by the uni-lingual workflow. The workflow is then executed on the device. The mechanism of the present invention performs a post-execution operation on the device, wherein the post-execution operation restores the language and locale environment settings of the managed device from those expected by the uni-lingual workflow to the saved language and locale environment settings. The managed device is then released.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a general process for executing a workflow on a managed device;

FIG. 2 is a block diagram of a uni-lingual data center environment;

FIG. 3 is a block diagram of a multi-lingual data center environment;

FIG. 4 illustrates a known process for executing a workflow in a multi-lingual environment;

FIG. 5 is a pictorial representation of a network of data processing systems in which illustrative aspects of the present invention may be implemented;

FIG. 6 is a block diagram of a data processing system that may be implemented as a server in accordance with illustrative aspects of the embodiment of the present invention;

FIG. 7 is a block diagram illustrating a data processing system in which the present invention may be implemented;

FIG. 8 is a diagram illustrating an exemplary data center in accordance with an illustrative embodiment of the present invention;

FIG. 9 illustrates an example device management workflow written to perform a task that is based on the day of the week setting of the device;

FIGS. 10-12 are text examples of the execution of the workflow illustrated in FIG. 9;

FIG. 13 is an example flowchart of a process for allowing traditional uni-lingual workflows to operate in a multi-lingual data center environment in accordance with an illustrative embodiment of the present invention;

FIG. 14 is an example flowchart of a detailed process for allowing traditional uni-language workflows to operate in a multi-lingual data center environment in accordance with an illustrative embodiment of the present invention; and

FIGS. 15A-C are text examples illustrating results returned from the workflow process in FIG. 14 in accordance with an illustrative embodiment of the present invention.

### DETAILED DESCRIPTION OF THE PREFERRED EMBODIMENT

FIGS. 5-7 are provided as exemplary diagrams of data processing environments in which embodiments of the present invention may be implemented. It should be appreciated that FIGS. 5-7 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 5 depicts a pictorial representation of a network of data processing systems in which aspects of the present invention may be implemented. Network data processing system 500 is a network of computers in which embodiments of the present invention may be implemented. Network data processing system 500 contains a network 502, which is the medium used to provide communications links between various devices and computers connected together within network data processing system 500. Network 502 may include connections, such as wire, wireless communication links, or fiber optic cables. In the depicted example, server 504 connects to network 502 along with storage unit 506. In addition, clients 508, 510, and 512 connect to network 502. These clients 508, 510, and 512 may be, for example, personal computers or network computers. In the depicted example, server 504 provides data, such as boot files, operating system images, and applications to clients 508-512. Clients 508, 510, and 512 are clients to server 504. Network data processing system 500 may include additional servers, clients, and other devices not shown.

In the depicted example, network data processing system 500 is the Internet with network 502 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 500 also may be implemented as a number of different types of networks, such as for example, an intranet, a local area network (LAN), or a wide area network (WAN). FIG. 5 is intended as an example, and not as an architectural limitation for different embodiments of the present invention.

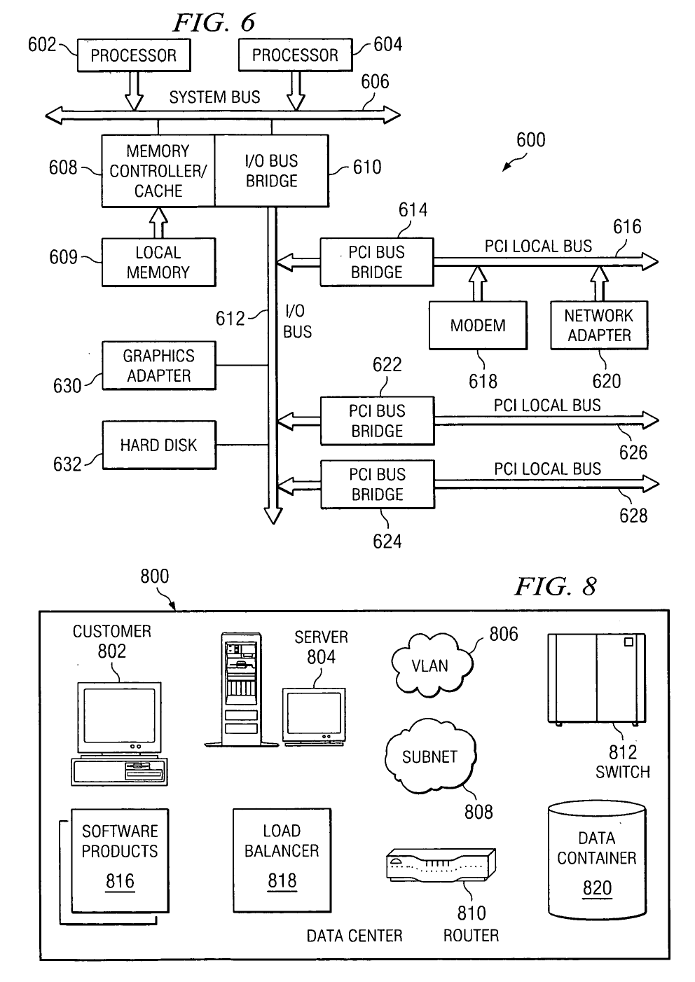

Referring to FIG. 6, a block diagram of a data processing system that may be implemented as a server, such as server 504 in FIG. 5, is depicted in accordance with an illustrative embodiment of the present invention. Data processing system 600 may be a symmetric multiprocessor (SMP) system including a plurality of processors 602 and 604 that connect to system bus 606. Alternatively, a single processor system may be employed. Also connected to system bus 606 is memory controller/cache 608, which provides an interface to local memory 609. I/O bus bridge 610 connects to system bus 606 and provides an interface to I/O bus 612. Memory controller/cache 608 and I/O bus bridge 610 may be integrated as depicted.

A bus system may be comprised of one or more buses, such as system bus 606, I/O bus 612 and PCI buses 616, 626 and 628 as shown in FIG. 6. Of course the bus system may be implemented using any type of communications fabric or architecture that provides for a transfer of data between different components or devices attached to the fabric or architecture. A communications unit may include one or more devices used to transmit and receive data, such as modem 618 or network adapter 620 of FIG. 6. A memory may be, for example, local memory 609 or cache such as found in memory controller/cache 608 of FIG. 6. A processing unit may include one or more processors or CPUs, such as processor 602 or processor 604 of FIG. 6.

Peripheral component interconnect (PCI) bus bridge 614 connects to I/O bus 612 provides an interface to PCI local bus 616. A number of modems may be connected to PCI local bus 616. Typical PCI bus implementations will support four PCI expansion slots or add-in connectors. Communications links to clients 508-512 in FIG. 5 may be provided through modem 618 and network adapter 620 connected to PCI local bus 616 through add-in connectors. Additional PCI bus bridges 622 and 624 provide interfaces for additional PCI local buses 626 and 628, from which additional modems or network adapters may be supported. In this manner, data processing system 600 allows connections to multiple network computers. A memory-mapped graphics adapter 630 and hard disk 632 may also be connected to I/O bus 612 as depicted, either directly or indirectly.

Those of ordinary skill in the art will appreciate that the hardware depicted in FIG. 6 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 6 may be, for example, an IBM eServer™ pSeries® computer system, running the Advanced Interactive Executive (AIX®) operating system or LINUX® operating system (eServer, pSeries and AIX are trademarks of International Business Machines Corporation in the United States, other countries, or both while Linux is a trademark of Linus Torvalds in the United States, other countries, or both).

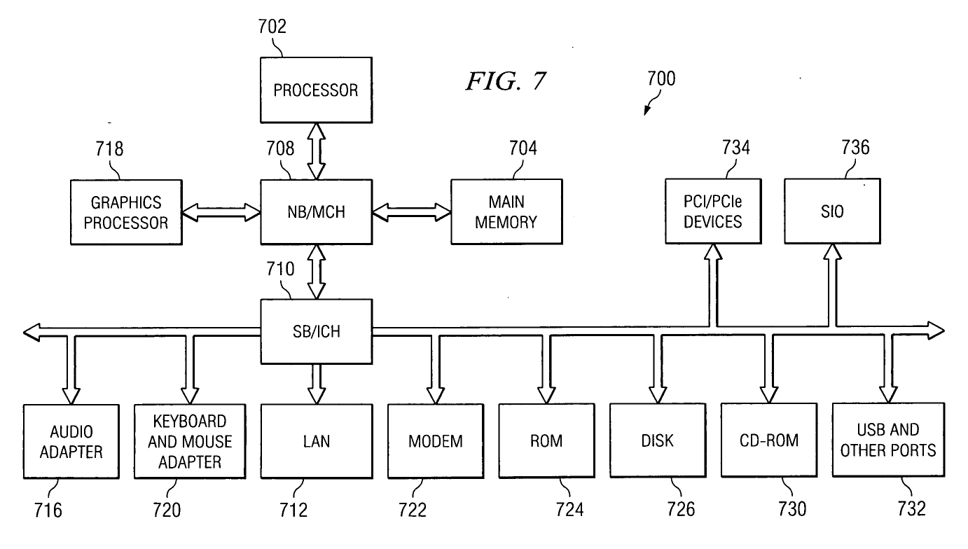

With reference now to FIG. 7, a block diagram of a data processing system is shown in which aspects of the present invention may be implemented. Data processing system 700 is an example of a computer, such as client 508 in FIG. 5, in which code or instructions implementing the processes for embodiments of the present invention may be located. In the depicted example, data processing system 700 employs a hub architecture including a north bridge and memory controller hub (MCH) 708 and a south bridge and input/output (I/O) controller hub (ICH) 710. Processor 702, main memory 704, and graphics processor 718 are connected to MCH 708. Graphics processor 718 may be connected to the MCH through an accelerated graphics port (AGP), for example.

In the depicted example, local area network (LAN) adapter 712, audio adapter 716, keyboard and mouse adapter 720, modem 722, read only memory (ROM) 724, hard disk drive (HDD) 726, CD-ROM drive 730, universal serial bus (USB) ports and other communications ports 732, and PCI/PCIe devices 734 connect to ICH 710. PCI/PCIe devices may include, for example, Ethernet adapters, add-in cards, PC cards for notebook computers, etc. PCI uses a card bus controller, while PCIe does not. ROM 724 may be, for example, a flash binary input/output system (BIOS). Hard disk drive 726 and CD-ROM drive 730 may use, for example, an integrated drive electronics (IDE) or serial advanced technology attachment (SATA) interface. A super I/O (SIO) device 736 may be connected to ICH 710.

An operating system runs on processor 702 and coordinates and provides control of various components within data processing system 700 in FIG. 7. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 700 (Java is a trademark of Sun Microsystems, Inc. in the United States, other countries, or both).

Instructions for the operating system, the object-oriented programming system, and applications or programs are located on storage devices, such as hard disk drive 726, and may be loaded into main memory 704 for execution by processor 702. The processes for embodiments of the present invention are performed by processor 702 using computer implemented instructions, which may be located in a memory such as, for example, main memory 704, memory 724, or in one or more peripheral devices 726 and 730. These processes may be executed by any processing unit, which may contain one or more processors.

Those of ordinary skill in the art will appreciate that the hardware in FIGS. 5-7 may vary depending on the implementation. Other internal hardware or peripheral devices, such as flash memory, equivalent non-volatile memory, or optical disk drives and the like, may be used in addition to or in place of the hardware depicted in FIGS. 5-7. Also, the processes of the present invention may be applied to a multiprocessor data processing system.

As an example, data processing system 700 may be a personal digital assistant (PDA), which is configured with flash memory to provide non-volatile memory for storing operating system files and/or user-generated data, as well as a tablet computer, laptop computer, or telephone device in addition to taking the form of a PDA.

Turning now to FIG. 8, a diagram illustrating an exemplary data center is depicted, in accordance with a preferred embodiment of the present invention. In particular, FIG. 8 depicts resources that may be employed in a data center, such as, for example, customer 802, server 804, Virtual Local Area Network (VLAN) 806, subnet 808, router 810, switch 812, software products 816, load balancer 818, and data container 820. The mechanism of the present invention allows using traditional workflows to manage multi-lingual data center environment resources, such as the example resources illustrated in FIG. 8.

As shown in this illustrative example, data center 800 includes resources, such as, customer 802, server 804, Virtual Local Area Network (VLAN) 806, subnet 808, router 810, switch 812, software products 816, load balancer 818, and data container 820. Customer 802 may be, for example, a client or an administrator who uses a data processing system, such as data processing system 700 in FIG. 7. Server 804 may be implemented as a data processing system, such as data processing system 600 in FIG. 6. Server 804 may also be implemented as an application server, which hosts Web services, or other types of servers. Router 810 and switch 812 facilitate communications between different devices. VLAN 806 is a network of computers that behave as if they are connected to the same wire even though they may actually be physically located on different segments of a local area network. Subnet 808 is a portion of a network, which may be a physically independent network segment and shares a network address with other portions of the network.

Software products 816 are applications that may be deployed to a client or a server. Load balancer 818 spreads traffic among multiple systems such that no single system is overwhelmed. Load balancer 818 is normally implemented as software running on a data processing system. Data container 820 may be a database, such as DB2 Universal Database, a product available from International Business Machines Corporation.

Data center 800, as depicted in FIG. 8, is presented for purposes of illustrating the present invention. Other resources, such as, for example, a cluster of servers and switch ports, also may be included in data center 800.

Embodiments of the present invention provide a method and system for allowing traditional uni-lingual workflows to work in multi-lingual data center environments. The processes of the present invention are performed by a processing unit that comprises one or more processors, such as processor 702 in FIG. 7, using computer implemented instructions, which may be located in a memory such as, for example, main memory 704, memory 724, or in one or more peripheral devices 726 and 730 in FIG. 7.

With the embodiments of the present invention, a workflow need not be changed in order to operate in a multi-lingual environment. To the contrary, the same workflow may be used to manage devices in the data center environment for all device language and locale environment settings. The illustrative embodiments of the present invention wrap the workflow with pre-execution and post-execution operations that insulate the workflow from the device's locale and language environment settings. The mechanism of the invention takes advantage of the tacit assumptions made by traditional and existing workflows, such as the managed device always responds to queries in English and that all devices in the data center respond in English. The mechanism of the present invention allows these existing workflows to continue to work in the “English-only” mode by dealing with the locale and language environment settings outside of the workflow execution unit. The mechanism of the present invention “deals” with these settings in pre-execution and post-execution operations.

The pre-execution operation takes place when the managed device is identified. When the managed device is identified, the pre-execution operation obtains the current language and locale environment settings for the device. The locale and language environment settings of the device may be obtained using commands. The commands utilized may be particular to the operating system employed. When a command is executed, the result of the command is used to identify the current locale and language settings of the device. For example, in an AIX® environment, the command “locale” is used to obtain the locale and language setting of the device. Some operating system platforms, such as HP-UX 10/11, Solaris (and other Unix platforms), and RedHat Linux 8.0 (and other Linux offerings) may use the locale command or a variant to obtain locale and language settings of the device as well. Other systems, such as Oracle, also provide facilities to query-the locale of a device. For example, in Oracle, a number of queries may be used to obtain the locale of the device. A “NLS₁₃ SESSION_PARAMETERS” query may be used to retrieve the current NLS parameters, which include the language and locale of the device, for the session. In Microsoft Windows, the locale identifier (LCID) is a 32-bit value that uniquely defines a locale. A “Query.LocaleID” query may be used to obtain the LCID.

Once the locale and language setting of the device are obtained, the pre-execution operation saves the settings of the device, and then changes the locale setting to that of the workflow locale. For example, if the device's language and locale is “German in Germany” (short form is “de₁₃ DE”), the pre-execution operation saves these settings. If the language and locale of the workflow is “English in the US” (short form is “en₁₃ US”), the pre-execution operation changes the locale of the device to “en₁₃ US” with the language to “English”. The locale settings of the device may also be changed using commands, wherein the commands depend on the operating system platform employed. For example, AIX®, HP-UX 10/11, Solaris (and other Unix platforms), and RedHat Linux 8.0 (and other Linux offerings) may execute a “LANG” command or a variant to change the locale settings of the device. Other systems, such as Oracle, may set the locale environment variable by executing an “NLS LANG” command, such as, for example, “setenv NLS_LANG FRENCH_FRANCE.WE8DEC” for setting a “French in France” locale. Alternatively, a “SQL ALTER SESSION” command may be used to set the locale for the session. For example, if the device locale is “French in France” and should be changed to German, a “SQL>ALTER SESSION SET NLS_LANGUAGE=GERMAN” command will change the locale to “German”. In Microsoft Windows, a “Session.LCID” command may be used to set the session locale.

Once the locale and language settings of the device have been changed, the workflow is then run. Once the workflow is completed, the post-execution operation uses the language and locale environment setting that was saved in the pre-execution operation to restore the language and locale environment setting of the device to its original environment. For example, the device locale may be changed, in the example above, from “en_US” with the language as “English” back to “de_DE” with the language as “German”.

An advantage of the present invention is that a traditional workflow may be used to manage the multi-lingual devices, rather than requiring multiple language versions of the same workflow to be able to work with each managed device locale and language environment setting. As shown in the illustrated embodiments of the present invention, the same workflow may be used for all locale and language environment settings of a device. Thus, with the present invention, the workflow is not changed to accommodate the multi-lingual environment. As a result, there is no maintenance issue of synchronizing multiple locale and language variations of the same workflow. In addition, the mechanism of the present invention allows for existing workflows to be used with minimal, if any, changes. The mechanism of the present invention also allows for the management of devices having currently identified locales and languages, as well as when new locales and languages are added to the data center environment. For example, the data center environment may contain resources having the U.S., Germany, and France as locales and English, German, and French as their respective languages. The addition to the data center environment of a resource having a new locale, such as Japan, and its respective language, Japanese, will not require a new workflow to be created to accommodate the Japanese language resource. This ability to easily add new locales provides a further advantage over existing methods of managing devices in a multi-lingual environment, as existing methods require that every additional locale and language encountered in the data center requires a new set of workflows for that new locale and/or language.

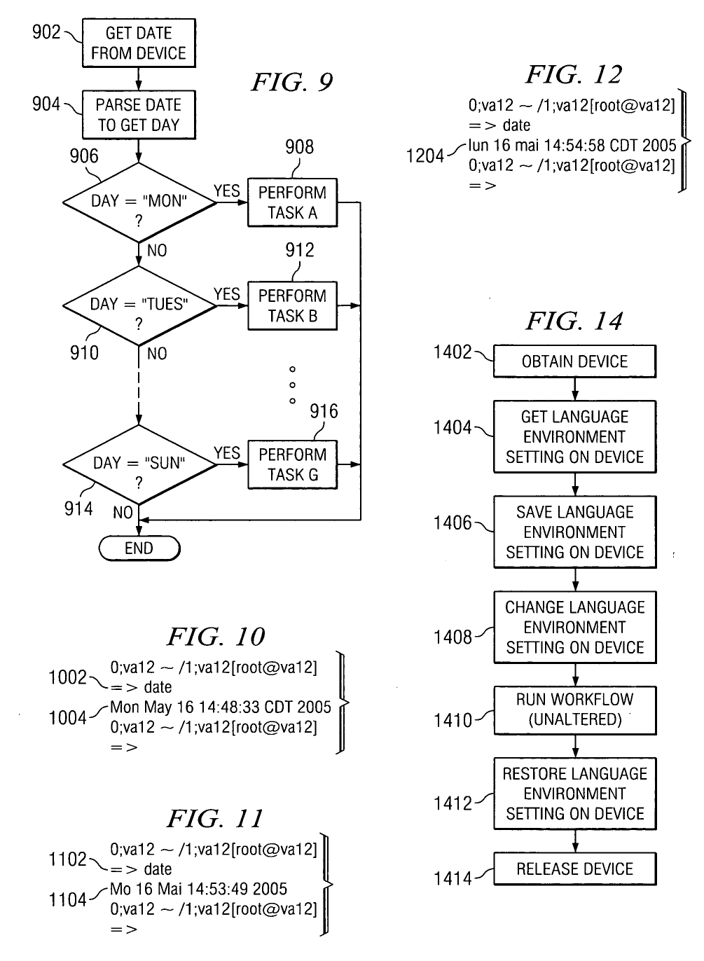

Turning now to FIG. 9, an example device management workflow is shown. In this particular illustrative example, the workflow has been written to perform a task that is based on the day of the week setting of the device. The workflow first obtains the date from the device (step 902), and the date is parsed to determine the day of the week (step 904). Using AIX® as an example operating system, the day may be returned in the workflow as part of the date. To obtain the date on an AIX® machine, the workflow may execute the “date” command. Date command 1002 and result 1004 of the command is shown in FIG. 10. Based on the day returned, a particular task may be performed in the workflow. For instance, if a determination is made that the day is “Mon” (step 906), task A is performed (step 908). If a determination is made that the day is “Tues” (step 910), task B is performed (step 912). Likewise, if a determination is made that the day is “Sun” (step 914), task G is performed (step 916). In this manner, a particular task may be performed based on the particular day of the week.

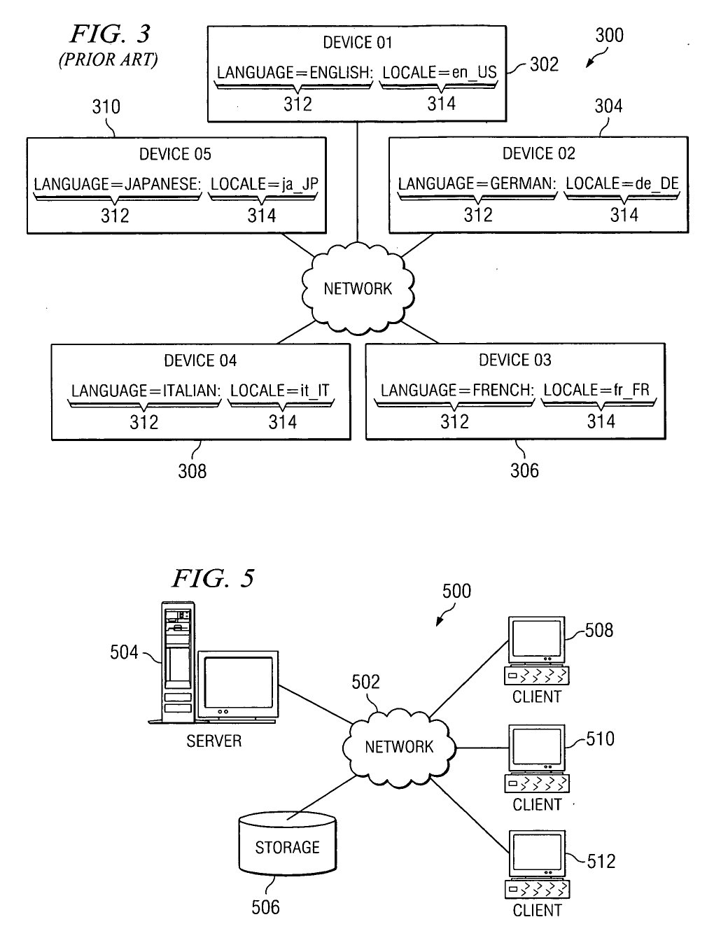

FIGS. 11 and 12 are text examples of the execution of the workflow illustrated in FIG. 9. The particular examples in FIGS. 11 and 12 illustrate the problem that not all workflows, such as the workflow in FIG. 9, may be properly executed in a multi-lingual environment. Again using AIX® as an example operating system, date command 1102 is shown to be issued in FIG. 11. Date command 1102 may be issued to a device, such as device 304 in FIG. 3. When date command 1102 is issued, the day of the week returned is “Mo” 1104, as the language for device 304 is German with the locale being “German in Germany”. In a contrasting example in FIG. 12, if the workflow is run on device 306, the day of the week returned in FIG. 12 is “lun” 1204, as the language for device 306 is French with the locale being “French in France”.

In view of the results obtained for the day of the week from the devices 304 and 306, the workflow diagram in FIG. 9 would not work properly in a multi-lingual environment. As the abbreviation of Monday in German is “Mo” and in French is “lun”, the workflow would never register that the condition in step 906, day=“Mon” in English, has been met. The consequences of executing a workflow on a device that does not respond in the language expected may run the gamut from harmless to rendering the device unusable.

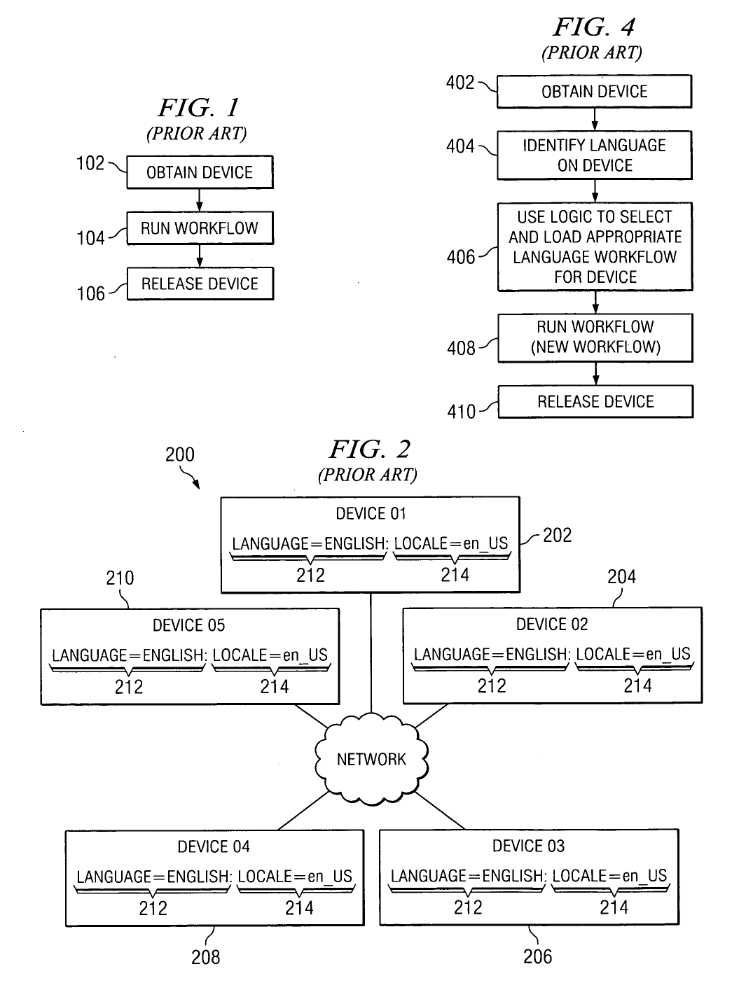

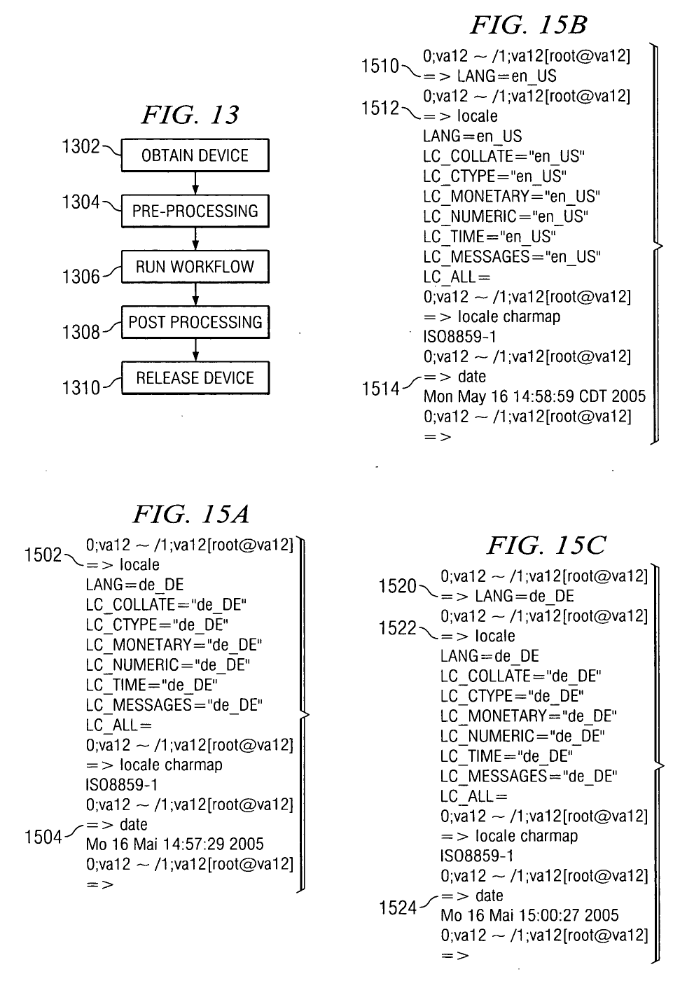

FIG. 13 illustrates an example flowchart of a process for allowing traditional uni-lingual workflows to operate in a multi-lingual data center environment in accordance with an illustrative embodiment of the present invention. The process illustrated in FIG. 13 improves upon the general process illustrated in FIG. 1 by allowing existing workflows to continue to expect English responses to queries by dealing with the locale and language environment settings outside of the workflow execution unit. As shown, the locale and language environment settings of a device are managed in pre-execution and post-execution operations.

In this illustrative example, the managed device is first obtained by the workflow process (step 1302). Next, a pre-execution operation is performed upon identifying the managed device (step 1304). The pre-execution operation is used to save the language and locale environment settings of the managed device. The pre-execution operation is also used to change the language and locale environment settings on the device to match the locale and language settings used in the workflow. The workflow is then executed on the device (step 1306). Once the workflow has been completed, a post-execution operation is performed on the device (step 1308). The post-execution operation returns the language and locale environment settings of the device back to its original settings. The workflow process then releases the device (step 1310).

FIG. 14 illustrates an example flowchart of a detailed process for allowing traditional uni-language workflows to operate in a multi-lingual data center environment in accordance with an illustrative embodiment of the present invention. The process in FIG. 14 illustrates the pre-execution and post-execution processes of FIG. 13 in further detail.

The process begins with the workflow process obtaining the device to be managed (step 1402). When the device is obtained, the pre-execution process is performed. The pre-execution process comprises first obtaining the current language and locale environment settings for the device (step 1404). The current language and locale environment settings for the device may include the locale setting, the language setting, and the charmap information for the device. For instance, the pre-execution operation changes the locale setting of the device. Using AIX®, Linux®, and UNIX® as examples, the locale and language environment settings may be obtained using a “locale” command, or a variant of the command. The character set description (charmap) source file for the device resolves problems with portability of locale definition sources. The charmap file may be used to define common locale definitions for multiple code sets, and the same locale definition source may then be used for code sets with different encodings. The charmap file defines character symbols as character encodings, and maps symbolic character names to code points, such as, for example, the symbol “A” mapped to code point hexadecimal 41 for the ASCII code set. These symbols may be used by the local definition source file to refer to character encodings.

Next, the pre-execution operation saves the obtained language and locale environment settings (e.g., locale, language, and charmap if needed) either in memory or in a file (step 1406). The pre-execution operation then changes the locale, and therefore the language, environment settings of the device (step 1408). For example, in AIX®, Linux®, and UNIX®, a “LANG” command or a variant may be used to change the device locale, and therefore the language, settings to the locale of the workflow. In this manner, the locale of device 304 in FIG. 3 may be changed from “German in Germany” with the language being German, to “English in the US” with the language being English. The workflow may then be run on the device (step 1410).

Once the workflow has successfully completed, the post-execution operation is then performed. The post-execution operation comprises restoring the language and locale environment setting of the device to its previous setting (step 1412). For example, the locale, and therefore the language, of device 304 in FIG. 3, current set to “English in the US” with the language being English, may be restored back to “German in Germany” with the language being German. The workflow process may then release the managed device (step 1414).

FIGS. 15A-15C are example screenshots illustrating results returned from the workflow process in FIG. 14 in accordance with an illustrative embodiment of the present invention. In particular, FIG. 15A shows a screenshot of results returned from performing step 1404 in FIG. 14, or obtaining the current language and locale environment of the device. As shown in this illustrative example, when “locale” command 1502 in an AIX® environment is issued, the managed device returns the locale setting of “German in Germany”. When “date” command 1504 is issued, the managed device returns the date “Mo 16 Mai 2005”. Thus, the day of the week for the device operating in German is “Mo”.

FIG. 15B illustrates a screenshot of results returned from performing step 1408 in FIG. 14, or changing the language and locale environment setting of the device. As shown, the locale setting of the device may be changed by issuing “LANG” command 1510 (LANG=en_US) in the AIX® environment, wherein the locale “English in the US” and the language assigned to the device is English. At this point, if “locale” command 1512 is issued to identify the language and locale settings of the device, the screenshot shows that the language and locale settings returned for the device are now English. When “date” command 1514 is issued, the managed device returns the date “Mon May 16 2005”. Thus, the day of the week for the device operating in English is “Mon”.

FIG. 15C illustrates a screenshot of results returned from performing step 1412 in FIG. 14, or restoring the language and locale environment setting of the device to its previous setting. The locale setting of the device is restored by issuing the “LANG” command 1520 (LANG=de_DE), wherein the language is restored from the setting saved in step 1406 in FIG. 14. As shown, when “locale” command 1522 is issued to identify the language and locale settings of the device, the screenshot shows that the language and locale settings returned for the device have been restored back to German. When “date” command 1524 is issued, the managed device returns the date “Mo 16 Mai 2005”. As can be seen, date command 1524 produces the same result as date command 1504 in FIG. 15A, which indicates a successful restoration of the language and locale environment of the device.

It should be noted that the mechanism of the present invention is not limited to only executing workflows written to expect English responses. The mechanism of the present invention also allows for workflows to be written to expect responses in any language. For example, a workflow may be written to expect responses in Arabic. As a result, in the example of the pre-execution operation described earlier, the local setting of the device may be changed to Arabic (e.g., ar_EG, for Arabic in Egypt) rather than changed to English (e.g., en_US). In other words, the mechanism of the present invention enables a uni-language workflow, in any language, to work and manage devices in a multi-lingual environment.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for using a uni-lingual workflow in a multi-lingual data center environment, the computer implemented method comprising:
obtaining a managed device in the multi-lingual data center environment;
identifying language and locale environment settings of the managed device;
performing a pre-execution process on the managed device to change the language and locale environment settings of the managed device to the language and locale settings expected by the uni-lingual workflow to form an altered managed device;
executing the uni-lingual workflow on the altered managed device;
performing a post-execution operation on the altered managed device to restore the language and locale environment settings of the managed device; and
releasing the managed device.

2. The computer implemented method of claim 1, wherein the language and locale environment settings for the managed device include at least one of a locale setting, a language setting, and charmap information, the pre-execution operation saves the language and locale environment settings of the managed device, and the post-execution operation restores the language and locale environment settings of the altered managed device using the saved language and locale environment settings.

3. The computer implemented method of claim 1, wherein the uni-lingual workflow is used to manage devices in the multi-lingual data center environment for all device language and locale environment settings.

4. The computer implemented method of claim 1, wherein the pre-execution and post-execution processes create a buffer to insulate the uni-lingual workflow from the locale and language environment settings of each managed device.

5. The computer implemented method of claim 1, wherein the managed device is a new managed device in the data center environment, and wherein the new managed device has a new locale and language, and wherein the same uni-lingual workflow is executed on the new managed device as other managed devices in the data center environment.

6. The computer implemented method of claim 1, wherein the identifying step comprises executing at least one of a command and a query to obtain to the language and locale environment settings of the managed device.

7. The computer implemented method of claim 1, wherein performing the pre-execution process comprises executing at least one command to change the language and locale environment settings of the managed device.

8. The computer implemented method of claim 1, wherein performing the post-execution operation comprises executing at least one command to restore the language and locale environment settings of the managed device.

9. A data processing system for using a uni-lingual workflow in a multi-lingual data center environment, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to identify language and locale environment settings of the managed device in response to obtaining the managed device in the multi-lingual data center environment, change the language and locale environment settings of the managed device to the language and locale settings expected by the uni-lingual workflow to form an altered managed device, execute the uni-lingual workflow on the altered managed device, restore the language and locale environment settings of the managed device, and release the managed device.

10. The data processing system of claim 9, wherein the language and locale environment settings for the managed device includes at least one of a locale setting, a language setting, and charmap information, a pre-execution operation saves the language and locale environment settings of the managed device, and a post-execution operation restores the language and locale environment settings of the altered managed device using the saved language and locale environment settings.

11. The data processing system of claim 9, wherein the uni-lingual workflow is used to manage devices in the multi-lingual data center environment for all device language and locale environment settings.

12. The data processing system of claim 9, wherein the managed device is a new managed device in the data center environment, and wherein the new managed device has a new locale and language, and wherein the same uni-lingual workflow is executed on the new managed device as other managed devices in the data center environment.

13. The data processing system of claim 9, wherein the computer usable code to identify language and locale environment settings comprises executing at least one command to obtain to the language and locale environment settings of the managed device.

14. The data processing system of claim 9, wherein the computer usable code to change the language and locale environment settings of the managed device comprises executing at least one command to change the language and locale environment settings of the managed device.

15. The data processing system of claim 9, wherein the computer usable code to restore the language and locale environment settings of the managed device comprises executing at least one command to restore the language and locale environment settings of the managed device.

16. A computer program product for using a uni-lingual workflow in a multi-lingual data center environment, the program product comprising:
a computer usable medium having computer usable program code tangibly embodied thereon, the computer usable program code comprising:
computer usable program code for identifying language and locale environment settings of a managed device in response to obtaining the managed device in the multi-lingual data center environment;
computer usable program code for performing a pre-execution process on the managed device, wherein the pre-execution operation changes the language and locale environment settings of the managed device to the language and locale settings expected by the uni-lingual workflow to form an altered managed device;
computer usable program code for executing the uni-lingual workflow on the altered managed device;
computer usable program code for performing a post-execution operation on the altered managed device, wherein the post-execution operation restores the language and locale environment settings of the altered managed device to restore the managed device; and
computer usable program code for releasing the managed device.

17. The computer program product of claim 16, wherein the language and locale environment settings for the managed device include at least one of a locale setting, a language setting, and charmap information, the pre-execution operation saves the language and locale environment settings of the managed device, and the post-execution operation restores the language and locale environment settings of the altered managed device using the saved language and locale environment settings.

18. The computer program product of claim 16, wherein the uni-lingual workflow is used to manage devices in the multi-lingual data center environment for all device language and locale environment settings.

19. The computer program product of claim 16, wherein the pre-execution and post-execution processes creates a buffer to insulate the uni-lingual workflow from the locale and language environment settings of each managed device.

20. The computer program product of claim 16, wherein the managed device is a new managed device in the data center environment, and wherein the new managed device has a new locale and language, and wherein the same uni-lingual workflow is executed on the new managed device as other managed devices in the data center environment.
